(19) United States
(12) Patent Application Publication
(10) Pub. No.: US 2026/0193433 A1
(43) Pub. Date: Jul. 9, 2026

(54) POLYURETHANE POLYISOCYANURATE RESINS FOR PULTRUSION CONTINUOUS FIBERCOMPOSITES WITH A STABLE AND LONG SHELF-LIFE

(71) Applicant: BASF SE, Ludwigshafen am Rhein (DE)

(72) Inventors: Ali Zolali, Canton, MI (US); Elias Ruda Shakour, Ann Arbor, MI (US)

(73) Assignee: BASF SE, Ludwigshafen am Rhein (DE)

(21) Appl. No.: 19/133,752

(22) PCT Filed: Feb. 23, 2024
(86) PCT No.: PCT/US2024/017040

§ 371 Date: May 29, 2025

Related U.S. Application Data
(60) Provisional application No. 63/487,396, filed on Feb. 28, 2023.

(51) Int. Cl. C08J 5/24; B29C 70/52; B29K 75/00; C08G 18/16; C08G 18/22

(52) U.S. Cl. CPC C08J 5/24; B29C 70/52; C08G 18/161; C08G 18/168; C08G 18/225; B29K 2075/00; B29K 2995/0017; B29K 2995/007; B29K 2995/0077; C08J 2375/04

(57) ABSTRACT

Disclosed is a process for producing a pultruded polyurethane-polyisocyanurate-fiber composite part, including obtaining a reaction mixture by mixing (A) an isocyanate-reactive component comprising a polyol having an average functionality of 1.8 to 5.0 and a hydroxyl number of 200 to 500, and alkali metal catalyst obtainable by introducing an alkali metal salt or alkaline earth metal salt into a compound R—NH—CO—R′ containing urethane groups, with R being not hydrogen and/or not COR″ and (B) an isocyanate component including at least one isocyanate compound, and a compound containing one or more epoxide groups; and impregnating at least one fibrous reinforcing agent with the reaction mixture to obtain the pultruded polyurethane-polyisocyanurate-fiber composite part.

### TECHNICAL FIELD

This disclosure relates to a polyurethane formulation and system for pultrusion applications, especially automotive pultrusion applications. The systems and formulations of this disclosure provide improved stability over existing systems, as well as excellent wet-out to glass fiber during pultrusion, overall high mechanical performance, high temperature stability and fast curing characteristics.

### BACKGROUND

Pultrusion is a process of making composites through impregnation of fibers, typically glass fiber, in a resin and pulling the resin and fibers through a heated die to cure and form the desired shape of the die. Typical resins used in a pultrusion process can be epoxy, urethane, polyester, vinylester or phenolic. The reinforcement fibers can be glass, carbon or aramid, and may be in the form of rowing/tow, mat, woven or stitched.

Currently there is a need for a pultrusion process and system for making polyurethane based composite articles with higher thermal stability, such as at temperatures as high as 200° C. for 30 min. The parts are needed to retain their mechanical performance after such a process and the existing polyurethane pultruded parts are not suitable for those applications. Additionally, the components must be stable enough the withstand storage for weeks or months. Thus, there is a need for a stable high temperature performance polyurethane system for such applications.

### SUMMARY

This disclosure relates to a process for producing polyurethane-polyisocyanurate-fiber composite parts, comprising obtaining a reaction mixture by mixing: an isocyanate-reactive component comprising: a polyol having an average functionality of 1.8 to 5.0 and a hydroxyl number of 200 to 500 and an alkali metal catalyst obtainable by introducing an alkali metal salt or alkaline earth metal salt into a compound R—NH—CO—R′ containing urethane groups, with R being not hydrogen and/or not COR″ with an isocyanate component comprising at least one isocyanate compound and a compound containing one or more epoxide groups; and impregnating at least one fibrous reinforcing agent with the reaction mixture to obtain the pultruded polyurethane-polyisocyanurate-fiber composite part. This disclosure further relates to a polyurethane-polyisocyanurate-fiber composite part producible by such a process.

### BRIEF DESCRIPTION OF THE FIGURES

FIG. 1A shows FTIR spectra of neat Isocyanate, Isocyanate/Epoxy mixture immediately after mixing, 30 min after mixing, and 14 days after mixing; b) neat Isocyanate and Isocyanate/epoxy mixture after 50 days.

FIG. 1B shows FTIR spectra of neat Isocyanate and Isocyanate/epoxy mixture after 50 days.

FIG. 2 shows a graph of the NCO content of an exemplary composition (diamond) compared to a control formulation (triangle).

FIG. 3 shows a graph of the gel-time aging of an exemplary composition.

FIG. 4A shows a DMA of the Tg stability of an exemplary composition after 48 hours.

FIG. 4B shows a DMA of the Tg stability of the exemplary composition of FIG. 4A after 4 months.

FIG. 5 shows the flexural modulus of the exemplary composition over 180 days.

FIG. 6 shows the flexural strength of the exemplary composition over 180 days.

FIG. 7A shows the elastic modulus (MPA) of an exemplary composition at room temperature.

FIG. 7B shows the flex strength (MPA) of an exemplary composition at room temperature.

FIG. 8A shows the elastic modulus (MPA) of an exemplary composition at 80° C.

FIG. 8B shows the flex strength (MPA) of an exemplary composition at 80° C.

### DETAILED DESCRIPTION

This disclosure relates to a unique polyurethane formulation and system including a two-part catalyst including an alkali metal catalyst obtainable by introducing an alkali metal salt or alkaline earth metal salt into a compound R—NH—CO—R′ containing urethane groups, with R being not hydrogen and/or not COR″ and a compound containing one or more epoxide groups. It has been surprisingly discovered that an alkali metal catalyst can make the isocyanate-side unstable and can cause the isocyanate to solidify after a short time (weeks to months). The inventors have discovered that including the alkali metal catalyst in the isocyanate-reactive side and including a compound containing one or more epoxide groups on the isocyanate-side provides for improved stability and long-term storage while also providing excellent physical properties.

The formulations and methods described herein provide the following advantages:
High glass transition so the mechanical performance is retained at elevated temperatures. For example, the polyurethane formulation and system of this disclosure advantageously allows for the production of composite pultruded parts that contain up to 80% glass fiber while having a glass transition up to over 230° C. and up to 275° C. without glass fiber, and over 200° C. and up to 245° in pultrusion process with glass fibers. In contrast, conventional formulations typically have a maximum glass transition around 150° C. and at higher costs.
Allows the automotive industry to embed the parts made by this formula in the body and have them go through the e-coating process of at least 20 min at high temperature.
Allows for the making of parts for use near the exhaust and replacement of metal parts.
Allows for usage in battery tray where all materials need to perform under high temp in case of fire.
The reactivity and thermal-mechanical properties of the systems for making molded and pultruded parts are stable for more than 6 months.

The formulations described herein may advantageously be used in a protrusion process. This disclosure provides a process for producing a pultruded polyurethane-polyisocyanurate-fiber composite part, comprising obtaining a reaction mixture by mixing:
an isocyanate-reactive component comprising:
   a polyol having an average functionality of 1.8 to 5.0 and a hydroxyl number of 200 to 500, and
   an alkali metal catalyst obtainable by introducing an alkali metal salt or alkaline earth metal salt into a compound R—NH—CO—R′ containing urethane groups, with R being not hydrogen and/or not COR″;
an isocyanate component comprising:
   at least one isocyanate compound, and
   a compound containing one or more epoxide groups; and
      impregnating at least one fibrous reinforcing agent with the reaction mixture to obtain the pultruded polyurethane-polyisocyanurate-fiber composite part.

### A. Isocyanate Component

The isocyanate component may include at least one isocyanate compound, such as a polyisocyanate and a compound containing one or more epoxide groups.

### 1. Isocyanate Compound

Suitable isocyanates, which may also be referred to herein as polyisocyanates, encompass all aliphatic, cycloaliphatic, and aromatic isocyanate known for the preparation of polyurethanes. They preferably have an average functionality of less than 2.5. Examples are 2,2′-, 2,4′-, and 4,4′-diphenylmethane diisocyanate, the mixtures of monomeric diphenylmethane diisocyanates and higher polycyclic homologs of diphenylmethane diisocyanate (polymeric MDI), isophorone diisocyanate (IPDI) or its oligomers, 2,4- or 2,6-tolylene diisocyanate (TDI) or mixtures thereof, tetramethylene diisocyanate or its oligomers, hexamethylene diisocyanate (HDI) or its oligomers, naphthylene diisocyanate (NDI), or mixtures thereof.

As polyisocyanates, preference is given to using monomeric diphenylmethane diisocyanate, for example 2,2′-diphenylmethane diisocyanate, 2,4′-diphenylmethane diisocyanate, 4,4′-diphenylmethane diisocyanate, or mixtures thereof. Here, diphenylmethane diisocyanate may also be used as a mixture with its derivatives. In that case, diphenylmethane diisocyanate may comprise with particular preference up to 10 wt %, with further particular preference up to 5 wt %, of carbodiimide-, uretdione- or uretonimine-modified diphenylmethane diisocyanate, especially carbodiimide-modified diphenylmethane diisocyanate.

Polyisocyanates may also be used in the form of polyisocyanate prepolymers. These polyisocyanate prepolymers are obtainable by reacting above-described polyisocyanates in excess, at temperatures for example of 30 to 100° C., preferably at about 80° C., with one or more polyols, to give the prepolymer.

The NCO content of polyisocyanate prepolymers is preferably from 5 to 33 wt % NCO, more preferably from 15 to 28 wt % NCO. Suitable polyisocyanate prepolymers may include the kinds are described for example in U.S. Pat. No. 3,883,571, WO 02/10250, and U.S. Pat. No. 4,229,347, each of which are incorporated herein by reference in their entirety.

Polyols are known to the skilled person and are described for example in “Kunststoffhandbuch, 7, Polyurethane”, “Carl Hanser-Verlag, 3rd edition 1993, section 3.1. As polyols, then, it is possible for example to use polyetherols or polyesterols. Preferred polyols comprising secondary OH groups, such as polypropylene oxide, for example. These polyols preferably possess a functionality of 2 to 6, more preferably of 2 to 4, and more particularly 2 to 3. With particular preference the polyols comprise polyesterols comprising hydrophobic substances, as described below.

Particularly preferred for use as polyisocyanate is diphenylmethane diisocyanate or a polyisocyanate prepolymer based on monomeric 4,4′-diphenylmethane diisocyanate or mixtures of 4,4′-diphenylmethane diisocyanate with its derivatives and polypropylene oxide having a functionality of 2 to 4 and also, optionally, dipropylene glycol or monomeric.

It is possible optionally for chain extenders to be added to the reaction to form the polyisocyanate prepolymer. Suitable chain extenders for the prepolymer are dihydric or trihydric alcohols, examples being dipropylene glycol and/or tripropylene glycol, or the adducts of dipropylene glycol and/or tripropylene glycol with alkylene oxides, preferably dipropylene glycol.

### 2. Compound Containing One or More Epoxide Groups

The compound containing one or more epoxide groups comprises a compound that comprises one, two, three or more epoxide groups per molecule, and may be an epoxy resin. Suitable compounds containing one or more epoxide groups may include mono- or polyfunctional oxiranes. Examples of monofunctional compounds containing one or more epoxide groups are, for example, glycidyl ethers of aliphatic and cycloaliphatic monohydroxy compounds with usually 2 to 20 carbon atoms, or ethylhexylglycidylether and glycidyl esters of aliphatic or cycloaliphatic monocarboxylic acids with usually 2 to 20 carbon atoms. The epoxide functionality, i.e., the number of epoxide groups per molecule is typically in the range from 1 to 3, in particular in the range from 1.2 to 2.5. Preferred among these are, in particular, glycidyl ethers of aliphatic or cycloaliphatic alcohols which preferably have 1, 2, 3 or 4 OH groups and 2 to 20 or 4 to 20 C atoms, as well as glycidyl ethers of aliphatic polyetherols which are 4 to 20 C atoms have. Suitable examples include:
Glycidyl ethers of saturated alkanols having 2 to 20 C atoms, such as, for example, C 2-C 20-alkyl glycidyl ethers, such as 2-ethylhexyl glycidyl ether;
Glycidyl ethers of saturated alkanepolyols having 2 to 20 carbon atoms, e.g. the glycidyl ethers of 1, 4-butanediol, 1,6-hexanediol, trimethylolpropane or Pentaerythritol, wherein the aforementioned glycidyl ether compounds usually has an epoxy functionality in the range of 1 to 3.0 and preferably in the range of 1, 2 to 2.5; Glycidyl ethers of polyetherols having 4 to 20 carbon atoms, for example glycidyl ethers of diethylene glycol, triethylene glycol, tetraethylene glycol, dipropylene glycol or tripropylene glycol;
Glycidyl ethers of cycloaliphatic alcohols having 5 to 20 C atoms, for example bisglycidyl ethers of cyclohexane-1,4-diyl, the bisglycidyl ethers of ring-hydrogenated bisphenol A or of ring-hydrogenated bisphenol F,
Glycidyl ethers of polyalkylene oxides having 2 to 4 C atoms, such as polyethylene oxide or polypropylene oxide;
and mixtures of the aforementioned substances.

The compound containing one or more epoxide groups is preferably liquid at 25° C. It is also possible to use mixtures of such compounds, which are preferably likewise liquid at 25° C.

In some aspects, the compounds containing one or more epoxide groups in the compound containing one or more epoxide groups may be used in an amount such that an equivalents ratio of epoxide group to isocyanate group in the isocyanate component is 0.1 to 2.0, more preferably 0.25 to 1.75, or more preferably 0.5 to 1.5.

The compound containing one or more epoxide groups may preferably include one or more epoxy thinners. Commercially available examples of epoxy thinners suitable for use as a compound containing one or more epoxide groups include EPODIL® 748, available from Evonik, Araldite DY-E available from Huntsman and DER 721 available from Olin.

The compound containing one or more epoxide groups is used preferably in an amount of 0.3 to 15 wt %, preferably 0.5 to 10 wt % and more particularly 0.8 to 5 wt %, based on the total weight of the compound containing one or more epoxide groups and isocyanate compound.

### B. Isocyanate-Reactive Component

The isocyanate-reactive component includes reactive component, such as a polyol having an average functionality of 1.8 to 5.0 and a hydroxyl number of 200 to 500, and an alkali metal catalyst obtainable by introducing an alkali metal salt or alkaline earth metal salt into a compound R—NH—CO—R′ containing urethane groups, with R being not hydrogen and/or not COR″.

### 1. Alkali Metal Catalyst

The alkali metal catalyst is a mixture obtainable by introducing an alkali metal salt or alkaline earth metal salt into a compound comprising urethane groups. The alkali metal catalyst used in this context is a compound reacts with the compound containing one or more epoxide groups to chemically form an active species at high temperature (>75° C.) leading to a PU/PIR reaction mechanism.

The alkali metal salt or alkaline earth metal salt compounds of the alkali metal catalyst encompass, in particular, salts of sodium, lithium, magnesium, and potassium, and ammonium compounds, preferably lithium or magnesium, with any desired anions, preferably with anions of organic acids such as carboxylates and more preferably of inorganic acids, such as nitrates, halides, sulfates, sulfites, and phosphates, more preferably still with anions of monoprotic acids, such as nitrates or halides, and especially nitrates, chlorides, bromides or iodides. Particular preference is given to using lithium chloride, lithium bromide, and magnesium dichloride, and especially lithium chloride. Alkali metal or alkaline earth metal salts of the invention can be used individually or as mixtures.

The compound comprising urethane groups is understood to be any desired compounds which are liquid or solid at 20° C. and comprise at least one urethane group R—NH—CO—R′, in which R is not hydrogen and/or is not COR″. The compound comprising urethane groups in the alkali metal catalyst here is preferably obtainable by reaction from a polyisocyanate and a compound having at least one OH group, preferably at least two OH groups. The polyisocyanate may be same as or different from the polyisocyanate used as the at least one isocyanate compound. For example, a first polyisocyanate may be used as the at least one isocyanate compound, and the compound containing urethane groups in the alkali metal catalyst may be a reaction product of a second polyisocyanate and a compound having an OH group.

Preference here is given to compounds which are liquid at 50° C., and more preferably those which are liquid at room temperature. A substance or component which is “liquid” in the context of the present invention means one which at the specified temperature has a viscosity of not more than 10 Pas. Where no temperature is specified, the datum is based on 20° C. Measurement in this context takes place according to ASTM D445-11.

The compounds comprising urethane groups preferably have at least two urethane groups. The molecular weight of these compounds comprising urethane groups is preferably in the range from 200 to 15 000 g/mol, more preferably 300 to 10 000 g/mol, and more particularly 500 to 1300 g/mol. Compounds comprising urethane groups may be obtained, for example, by reaction of aforementioned isocyanates as a second isocyanate with compounds which have at least one hydrogen atom that is reactive toward isocyanates, such as alcohols, examples being monoalcohols, such as methanol, ethanol, propanol, butanol, pentanol, hexanol, or longer-chain propoxylated or ethoxylated monools, such as poly(ethylene oxide) monomethyl ether, such as, for example, the monofunctional PLURIOL® products from BASF, dialcohols, such as ethylene glycol, diethylene glycol, triethylene glycol, propylene glycol, dipropylene glycol, butanediol, hexanediol, and/or reaction products of said isocyanates with the below-described polyols and/or chain extenders—individually or in mixtures.

To prepare the compound comprising urethane groups it is possible to employ not only isocyanates but also polyols in a stoichiometric excess. Where monoalcohols are used, isocyanate groups and OH groups may also be used in a stoichiometric ratio. Where the compound comprising urethane groups has two or more isocyanate groups per molecule, they may wholly or partly replace the polyisocyanates.

A reaction may take place customarily at temperatures between 2° and 120° C., for example at 80° C. The second isocyanate, used for preparing the compound comprising urethane groups, is preferably an isomer or homolog of diphenylmethane diisocyanate. More preferably the second isocyanate is monomeric diphenylmethane diisocyanate, for example 2,2′-diphenylmethane diisocyanate, 2,4′-diphenylmethane diisocyanate, 4,4′-diphenylmethane diisocyanate, or a mixtures thereof. This diphenylmethane diisocyanate may also be used as a mixture with its derivatives. In that case, diphenylmethane diisocyanate may with particular preference comprise up to 10 wt %, with further particular preference up to 5 wt %, of carbodiimide-, uretdione-, or uretonimine-modified diphenylmethane diisocyanate, especially carbodiimide-modified diphenylmethane diisocyanate. In a particularly preferred embodiment, the first isocyanate and the second isocyanate for preparing the compound comprising urethane groups are identical.

The compound comprising urethane groups may also be obtained via alternative reaction pathways, as for example by reacting a carbonate with a monoamine to form a urethane group. For this purpose, for example, a propylene carbonate is reacted in a slight excess (1.1 eq) with a monoamine, e.g., a JEFFAMIN® M 600, at 100° C. The resulting urethane may likewise be used as a compound comprising urethane group.

The mixtures comprising the alkali metal or alkaline earth metal salts and a compound comprising urethane groups may be obtained, for example, by mixing the alkali metal or alkaline earth metal salt into the compound comprising urethane groups, at room temperature or at elevated temperature above room temperature, for example. This may be done using any mixer, such as a single stirrer, for example. The alkali metal or alkaline earth metal salt in this case may be used as a pure substance or in the form of a solution, in mono- or polyfunctional alcohols, for example, such as methanol, ethanol, or chain extender, or water. In one particularly preferred embodiment, commercially available prepolymer-based isocyanate is admixed directly with the dissolved salt. Suitable for this purpose for example are isocyanate prepolymers having an NCO content of 15% to 30%, based in particular on diphenylmethane diisocyanate and a polyether polyol. Isocyanates of this kind are available commercially for example from BASF under the trade name LUPRANAT® MP 102.

In one particularly preferred embodiment of the present invention, the alkali metal or alkaline earth metal salt is dissolved in a compound having hydrogen atoms that are reactive toward isocyanate, and this solution is subsequently mixed with the isocyanate, optionally at elevated temperature.

Particular preference is given to preparing the compound comprising urethane groups using a monool having a molecular weight of 30 to 15 000 g/mol, preferably 100 to 900 g/mol and, in a particularly preferred version, of 400 to 600 g/mol.

The amount of alkali metal or alkaline earth metal ions per urethane group in the alkali metal catalyst is 0.0001 to 3.5, preferably 0.01 to 1.0, more preferably 0.05 to 0.9, and more particularly 0.1 to 0.8, based in each case on the number of alkali metal or alkaline earth metal ions and urethane groups (per equivalent of urethane groups).

The amount of alkali metal or alkaline earth metal ions per isocyanate group in the isocyanate component and also, if present, in the alkali metal catalyst is preferably 0.0001 to 0.3, more preferably 0.0005 to 0.02 and more particularly 0.001 to 0.01 equivalent, based in each case on the number of alkali metal or alkaline earth metal ions and urethane groups.

The amount of alkali metal or alkaline earth metal ions per epoxy group of the compound containing one or more epoxide groups is preferably greater than 0.00001 and is more preferably 0.00005 to 0.3, based in each case on the number of alkali metal or alkaline earth metal ions and epoxy groups.

Between the alkali metal or alkaline earth metal salt in the alkali metal catalyst, preferably at 25° C., there is a thermally reversible interaction with the compounds comprising urethane groups, whereas at temperatures greater than 50° C., preferably from 60 to 200° C. and more particularly from 80 to 200° C., the catalytically active compound is in free form. For the purposes of this disclosure, a thermally reversible interaction is assumed when the open time of the reaction mixture at 25° C. is longer by a factor of at least 5, more preferably at least 10 and more particularly at least 20, than at 80° C. The open time here is defined as the time within which the viscosity of the reaction mixture increases at constant temperature to an extent such that the required stirring force exceeds the given stirring force of the Shyodu Gel Timer, model 100, version 2012. For this purpose, 200 g in each case of reaction mixture were prepared, were mixed in a Speedmixer at 1950 rpm for 1 minute, and 130 g of the mixture, at room temperature or elevated reaction temperature in an oven, in a PP beaker with a diameter of 7 cm, were stirred using a Shyodu Gel Timer, model 100, version 2012 and an associated wire stirrer, at 20 rpm, until the viscosity and hence the required stirring force for the reactive mixture exceeded the stirring force of the Gel Timer.

### 2. Polyol

The isocyanate-reactive component includes a polyol, such as a polyol having an average functionality of 1.8 to 5.0 and a hydroxyl number of 200 to 500.

As polyetherol having an average functionality of 1.8 to 5.0, preferably 1.9 to 4.8 and more preferably 1.95 to 4.4 and a hydroxyl number of 200 to 500, preferably 250 to 450 and more particularly 300 to 400 mg KOH/g, it is possible to use customary polyetherols featuring these parameters. As isocyanate-reactive groups, there may be groups such as OH, SH and NH groups present. The polyols preferably have substantially OH groups, more preferably exclusively OH groups, as isocyanate-reactive groups.

In one preferred embodiment the polyols have at least 40%, preferably at least 60%, more preferably at least 80% and more particularly at least 95% of secondary OH groups, based on the number of isocyanate-reactive groups. In a further preferred embodiment, the polyols have at least 60%, more preferably at least 80% and more particularly at least 95% of primary OH groups, based on the number of isocyanate-reactive groups. The calculation of the average OH number and also the average functionality here is made on the basis of all polyetherols used.

The polyetherols are obtained in the presence of catalysts by known methods, as for example by anionic polymerization of alkylene oxides with addition of at least one starter molecule, comprising 2 to 4, preferably 2 to 3 and more preferably 2 reactive hydrogen atoms in bound form. Catalysts used may be alkali metal hydroxides, such as sodium or potassium hydroxide, or alkali metal alkoxides, such as sodium methoxide, sodium or potassium ethoxide or potassium isopropoxide, or Lewis acids in the case of cationic polymerization, such as antimony pentachloride, boron trifluoride etherate or bleaching earth as catalysts. As catalysts it is additionally possible to use double metal cyanide compounds, known as DMC catalysts. For polyetherols having hydroxyl numbers >200 mg KOH/g, a tertiary amine, such as imidazole, for example, may also be employed as catalyst. Such polyols are described for example in WO 2011/107367, which is incorporated herein by reference in its entirety.

As alkylene oxides, use is made preferably of one or more compounds having 2 to 4 carbon atoms in the alkylene radical, such as tetrahydrofuran, 1,2-propylene oxide, or 1,2- and/or 2,3-butylene oxide, in each case alone or in the form of mixtures, and preferably 1,2-propylene oxide, 1,2-butylene oxide and/or 2,3-butylene oxide, especially 1,2-propylene oxide.

Starter molecules contemplated include, for example, ethylene glycol, diethylene glycol, glycerol, trimethylolpropane, pentaerythritol, sucrose, methylamine, ethylamine, isopropylamine, butylamine, benzylamine, aniline, toluidine, toluenediamine, naphthylamine, ethylenediamine, diethanolamine, triethanolamine, and also other, especially dihydric alcohols.

### C. Fibrous Reinforcing Agent

Fibrous reinforcing agents may be fibers, such as glass fibers, aramid fibers, carbon fibers or fibers made of plastic. Reinforcing agents of these kinds are known and are commonly used in the production of fiber-reinforced plastics. The fibrous reinforcing agents are preferably used in plies. Such fiber plies are obtained, for example, by linking together individual fibers. In one preferred embodiment, the fibrous reinforcing agents consist of laid scrims, woven fabrics or knitted fabrics based on glass fibers, aramid fibers, carbon fibers or fibers made of plastic. Reinforcing-agent plies of these kinds are known and are available commercially. Glass fiber mats are employed in particular.

In some aspects, at least one fibrous reinforcing agent may be used in a range of 25 wt % to 80 wt % of the reaction mixture comprising the isocyanate-reactive component and the isocyanate component. More preferably, the at least one fibrous reinforcing agent may be used in a range of 30 wt % to 75 wt % of the reaction mixture, or 35 wt % to 70 wt % of the reaction mixture

### D. Additional Components

It is possible that either or both the isocyanate-reactive component or the isocyanate component may include one or more additional components as desired. For modifying the mechanical properties, such as the hardness, it may prove advantageous to add chain extenders, crosslinking agents or else, optionally, mixtures of these. In the case of the production of a composite material of the invention, a chain extender may be used. However, it is also possible to do without the chain extender.

Where low molecular weight chain extenders are used, it is possible to use chain extenders known in connection with the preparation of polyurethanes. These are, preferably, aliphatic and cycloaliphatic and/or araliphatic or aromatic diols and optionally triols having 2 to 14, preferably 2 to 10, carbon atoms, such as ethylene glycol, 1,3-propanediol, 1,4-butanediol, 1,6-hexanediol, 1,10-decanediol and bis(2-hydroxyethyl) hydroquinone, 1,2-, 1,3- and 1,4-dihydroxycyclohexane, diethylene glycol, dipropylene glycol, tripropylene glycol, triols, such as 1,2,4- and 1,3,5-trihydroxycyclohexane, glycerol and trimethylolpropane.

Preferably, in addition to the polyol of the isocyanate-reactive component and the chain extenders, less than 50 wt %, particularly preferably less than 30 wt %, more preferably less than 10 wt % and in particular no further compounds are used that have isocyanate-reactive hydrogen atoms, such as polyesters or polycarbonate diols, based on the total weight of the polyol of the isocyanate-reactive component, chain extender and the further compounds having isocyanate-reactive hydrogen atoms.

Further it is possible to use additives for water adsorption. Preferred additives for water adsorption that are used are aluminosilicates, selected from the group of the sodium aluminosilicates, potassium aluminosilicates, calcium aluminosilicates, cesium aluminosilicates, barium aluminosilicates, magnesium aluminosilicates, strontium aluminosilicates, sodium aluminophosphates, potassium aluminophosphates, calcium aluminophosphates and mixtures thereof. Particular preference is given to using mixtures of sodium, potassium and calcium aluminosilicates in a castor oil vehicle.

The additive for water absorption preferably has an average particle size of not greater than 200 μm, more preferably not greater than 150 μm and in particular not greater than 100 μm. The pore size of the additive of the invention for water absorption is preferably 2 to 5 angstroms. Besides the inorganic additives for water adsorption, it is also possible to use known organic additives for water adsorption, such as orthoformates, an example being triisopropyl orthoformate.

If an additive for water absorption is added, this is preferably in amounts greater than one part by weight, more preferably in the range from 1.2 to 2 parts by weight, based on the total weight of the polyisocyanurate system.

If polyurethane foams are to be produced, it is also possible, instead of water scavengers, to use chemical and/or physical blowing agents that are customary within polyurethane chemistry. Chemical blowing agents are understood to be compounds which as a result of reaction with isocyanate form gaseous products, such as water or formic acid, for example. Physical blowing agents are understood to be compounds which are present in solution or emulsion in the ingredients of polyurethane preparation and which evaporate under the conditions of polyurethane formation. Examples are hydrocarbons, halogenated hydrocarbons, and other compounds, such as, for example, perfluorinated alkanes, such as perfluorohexane, fluorochlorohydrocarbons, and ethers, esters, ketones, acetals or mixtures thereof, as for example (cyclo) aliphatic hydrocarbons having 4 to 8 carbon atoms, or hydrofluorocarbons, such as SOLKANER 365 mfc from Solvay Fluorides LLC. With preference no blowing agent is added.

Flame retardants which can be used are, in general, the flame retardants known from the prior art. Examples of suitable flame retardants are brominated ethers (Ixol B 251), brominated alcohols, such as dibromoneopentyl alcohol, tribromoneopentyl alcohol and PHT-4 diol, and also chlorinated phosphates, such as, for example, tris(2-chloroethyl) phosphate, tris(2-chloroisopropyl) phosphate (TCPP), tris(1,3-dichloroisopropyl) phosphate, tris(2,3-dibromopropyl) phosphate and tetrakis(2-chloroethyl)ethylene diphosphate, or mixtures thereof.

Besides the halogen-substituted phosphates already stated, it is also possible for inorganic flame retardants, such as red phosphorus, preparations comprising red phosphorus, expandable graphite, aluminum oxide hydrate, antimony trioxide, arsenic oxide, ammonium polyphosphate and calcium sulfate, or cyanuric acid derivatives, such as melamine, or mixtures of at least two flame retardants, such as ammonium polyphosphates and melamine, and also, optionally, starch, to be used in order to impart flame retardancy to the rigid polyurethane foams produced in accordance with the invention.

As further liquid, halogen-free flame retardants it is possible to use diethyl ethanephosphonate (DEEP), triethyl phosphate (TEP), dimethyl propylphosphonate (DMPP), diphenyl cresyl phosphate (DPK) and others.

In the context of the present invention, the flame retardants are used preferably in an amount of 0 to 60 wt %, more preferably of 5 to 50 wt %, more particularly of 5 to 40 wt %, based on the total weight of components (b) to (e).

Internal release agents which can be used are all release agents customary in the preparation of polyurethanes, examples being metal salts in solution in diamine, such as zinc stearate, and derivatives of polyisobutylenesuccinic acid. It is also possible to use further additives customary within polyurethane chemistry, such as stabilizers, UV absorbers or antioxidants.

### E. Polyurethane Systems and Processes

A polyurethane system of the invention preferably comprises less than 0.5 wt %, more preferably less than 0.3 wt %, of water, based on the total weight of components (b) to (e).

A pultruded polyurethane-polyisocyanurate-fiber composite part can be prepared by mixing the isocyanate-reactive component and isocyanate component and optionally additional components to form a reaction mixture, applying the reaction mixture to the fibrous reinforcing agent to impregnate the fibrous reinforcing agent, drawing the impregnated fibrous reinforcing agent through a die or mold, and completing the reaction to obtain a polyurethane-polyisocyanurate-fiber composite part. The reaction mixture may be pultruded at a temperature of about 150-250° C. or about 200-210° C. to form a polyisocyanurate.

For the purposes of the invention here, the mixture of the isocyanate-reactive component and isocyanate component is referred to as a reaction mixture at reaction conversions of less than 90%, based on the isocyanate groups. Individual components may already have been premixed. The isocyanate-reactive and isocyanate components may be mixed at about 1:3 ratio, for example about a 1:10 ratio to about a 1:1 ratio.

The isocyanate-reactive component and isocyanate component may be mixed at room temperature, but may be mixed at elevated temperatures. The reaction mixture is a temperature activated formulation and it has a long shelf-life of more than 10 hours at room temperature after mixing. The activation temperature is about 75-85° C.

Reaction mixtures have a long open time at 25° C., of more than 60 minutes for example, preferably of more than 90 minutes and more preferably of more than 120 minutes. The open time here is determined as described above, via the increase in viscosity. Raising the temperature to temperatures greater than 60° C., preferably 70 to 120° C., more preferably to 70 to 100° C., and especially 75 to 95° C., cures the reaction mixture of the invention rapidly, in less than 50 minutes, for example, preferably in less than 30 minutes, more preferably in less than 20 minutes, and more particularly in less than 10 minutes. Curing of a reaction mixture refers, for the purposes of this disclosure, to the increase from the initial viscosity to ten times the initial viscosity. The difference between the open time at 25° C. and the open time at 80° C. here is preferably at least 40 minutes, more preferably at least an hour and very preferably at least 2 hours.

The isocyanate index for a process of the invention is in the range from 100 to 450, preferably 125 to 425, more preferably 150 to 400, very preferably 175 to 375 and more particularly 200 to 350. The isocyanate index in the context of the present invention refers to the stoichiometric ratio of isocyanate groups to isocyanate-reactive groups, multiplied by 100. Isocyanate-reactive groups are all groups reactive with isocyanate that are present in the reaction mixture, including chemical blowing agents and compounds having epoxide groups, but not the isocyanate group itself.

In some aspects of this disclosure, preferably, a compact material is obtained; in other words, no blowing agent is added. Small amounts of blowing agent, for example small amounts of water which condense into the reaction mixture or the starting components in the course of processing, via atmospheric humidity, are not included in the last statement. A compact polyurethane-polyisocyanurate-fiber composite part refers to a polyurethane-polyisocyanurate-fiber composite part which is substantially free from gas inclusions. The density of a compact polyurethane-polyisocyanurate-fiber composite part is preferably greater than 0.8 g/cm³, more preferably greater than 0.9 g/cm³ and more particularly greater than 1.0 g/cm³, without taking into consideration the proportion of fibers.

Apart from the alkali metal or alkaline earth metal salt used in the alkali metal catalyst, the formulation may exclude compounds used in the process of the invention for accelerating the isocyanate-polyol reaction, such as the usual polyurethane catalysts based on compounds having tertiary amine groups. The polyurethane-polyisocyanurate-fiber composite parts of the invention are notable for outstanding mechanical properties, which can be varied within wide limits.

The process of the invention permits excellent wetting without defects, and rapid curing at 70 to 250° C., preferably 100 to 230° C. and more particularly 150 to 220° C. The polyurethane-polyisocyanurate-fiber composite moldings obtained possess outstanding mechanical properties and a very good surface.

A further subject of this disclosure is the polyurethane-polyisocyanurate-fiber composite part obtainable by the disclosed processes, and the use of a polyurethane-polyisocyanurate-fiber composite part for producing a large number of composite materials, for example in pultrusion, for the production, for example, of bodywork components for vehicles, door or window frames or honeycomb-reinforced components, or in vacuum-assisted resin infusion, for production, for example, of structural or semistructural components for vehicles or wind turbines.

The composite materials with the polyurethane-polyisocyanurate-fiber composite part may be used, furthermore, for production—mass production, for example—of parts for vehicles, components for trains, air travel and space travel, marine applications, wind turbines, structural components, adhesives, packaging, encapsulating materials and insulators. The polyurethane-polyisocyanurate-fiber composite part is used preferably for producing structural or semistructural components for wind turbines, vehicles, such as bumpers, fenders or roof parts, and marine applications, such as rotor blades, spiral springs or ship's bodies. Structural components here are understood to be those obtained using long fibers with an average fiber length of more than 10 cm, preferably more than 50 cm, while semistructural components are understood to be those obtained using short fibers having an average fiber length of less than 10 cm, preferably less than 5 cm.

### EXAMPLES

### Comparative Example 1

A polyurethane-polyisocyanurate composition was prepared according to Table 1.

TABLE 1

| | PBW |
|---|---|
| Isocyanate-Reactive Component | |
| Base Polyol | 62 |
| Chain extender | 25 |
| Release agent | 8 |
| Catalyst | 10 |
| Base polyol | 5 |
| Isocyanate Component | |
| Lupranate Isocyanate | 95 |
| Alkali metal Catalyst | 5 |

During lab evaluations of Comparative Example 1, instabilities were observed with the isocyanate mixture containing the alkali metal catalyst. The instabilities in the lab were in the form of solid formations over a short time (weeks to few months).

### Example 1: Formulation Stability

A polyurethane-polyisocyanurate composition was prepared according to Table 2 and its properties were analyzed.

TABLE 2

| | PBW |
|---|---|
| Isocyanate-Reactive Component | |
| Base Polyol | 52.35 |
| Chain extender | 21.25 |
| Release agent | 6.8 |
| Alkali Metal Catalyst | 14.25 |
| Base polyol | 3.85 |
| Moisture scavenger | 1.5 |
| Isocyanate Component | |
| LUPRANATE ® Isocyanate | 96.5 |
| Epoxide Catalyst | 3.5 |
| Gel time (min) at RT | 617 |
| Gel time (min) at 120° C. | 3:20 |
| Flex Modulus (MPa) @ RT | 1950 |
| (ASTM D790) | |
| Flex Modulus (MPa) @ 100° C. | 1430 |
| (ASTM D790) | |
| Flex Modulus (MPa) @ 150° C. | 1200 |
| (ASTM D790) | |
| Hardness Shore D (ASTM D2240) | 82 |
| HDT @ 264 PSI (° C.) | 185 |

The system of Example 1 showed very good DMA properties. The resulting composition had a Tg above 265° C. and a consistent high Elastic modulus with increasing temperature up to 210° C. The results suggest a very high temperature stable system considering the thermodynamic performance.

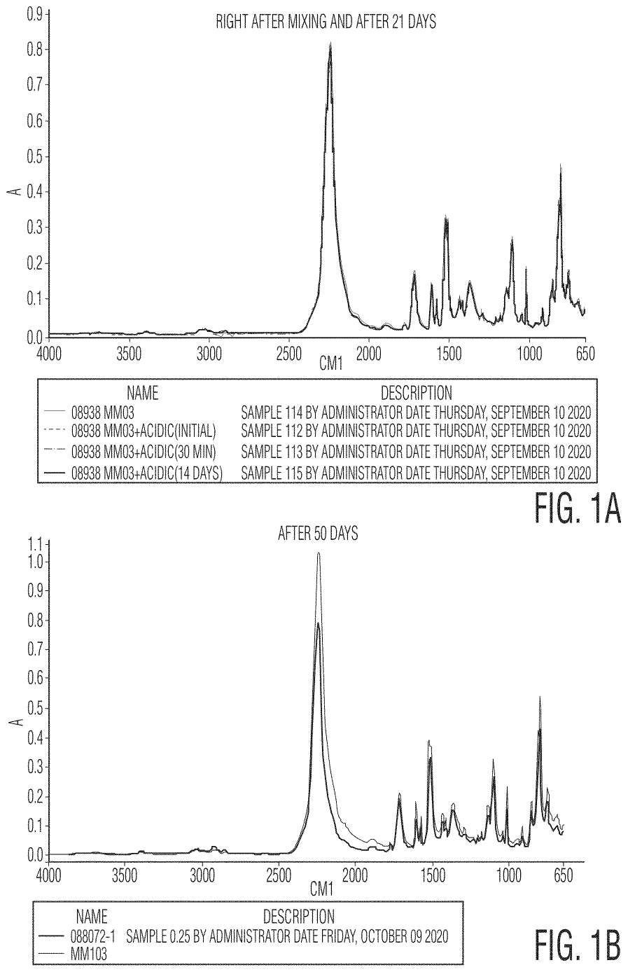

The stability of the isocyanate component was examined to confirm that the system provides a stable shelf-life. FTIR spectra of the isocyanate LUPRANATE® Isocyanate and Epodil 748 in the isocyanate component of Example 1 were examined for possible reactions between isocyanate and epoxy mixture over time. FIGS. 1A and 1B show the results at different times after mixing Isocyanate and an epoxide compound compared to that of the neat Isocyanate (without an epoxide compound). The spectra of the mixtures immediately after mixing, 30 min after mixing, 14 days and 50 days after mixing all substantially matches that of the neat Isocyanate. This suggests that there is little to no interaction between Isocyanate and an epoxide compound at room temperature.

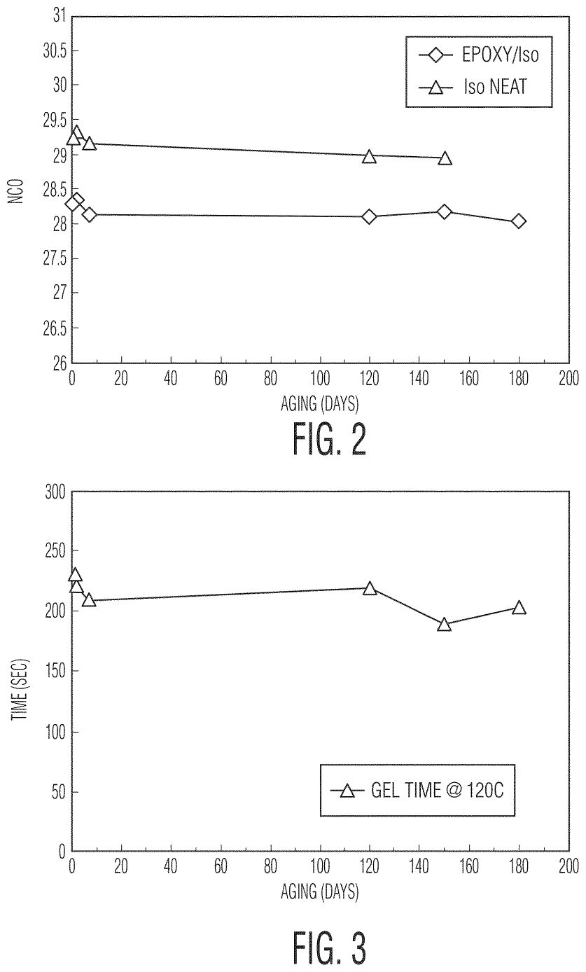

The NOC content of the Isocyanate mixtures were also evaluated over six months to see if there is any change compared to the neat Isocyanate. FIG. 2 shows the results confirming that the epoxide compound does not change the NCO content of the mixture, and it is stable up to six months of storage. The difference between the NCO content of the neat Isocyanate and the mixture will be eliminated if the NCO content of the mixture is normalized considering the 3.5% epoxy in the mixture. Therefore, there is no change in the NCO content suggesting a stable mixture.

In addition, the gel time of the system was evaluated after aging the component A and B mixtures over six months of storage. The results in FIG. 3 shows that the gel time at 120° C. is between 190 to 220 sec with no significant change after six months. This further confirms the stability of the system.

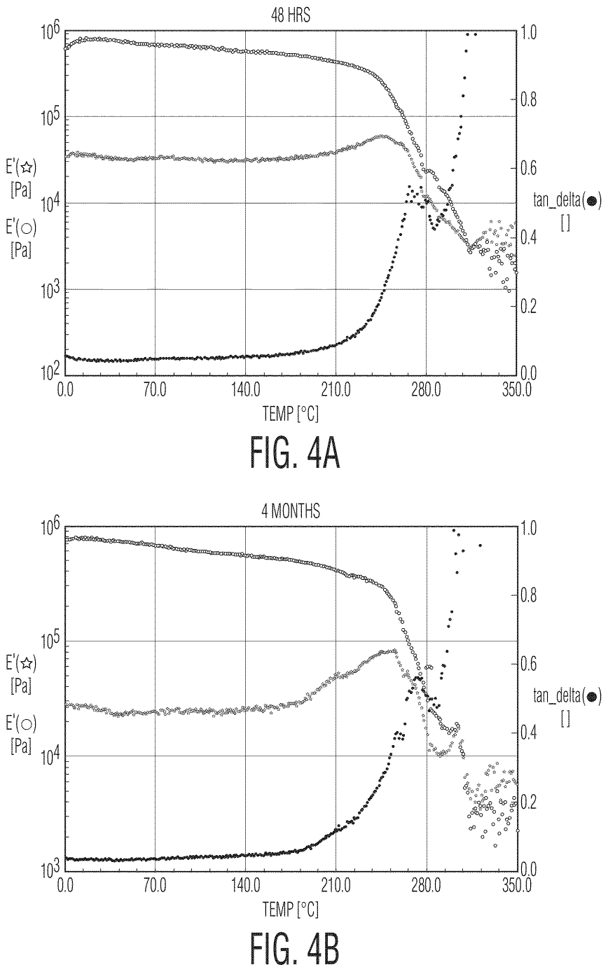

The Tg was measured at a temperature ranging from 0 to 300° C. The results in FIGS. 4A and 4B show consistent Tg over 250° C. even with aging up to four months.

### Example 2: Test Plaques

Test plaques were prepared by mixing the isocyanate component and isocyanate-reactive component mixtures of Example 1 in a vacuum speed mixer at 800 rpm and 14 torr for 5 min. The components mixture was also degassed and mixed at 2000 rpm for 10 sec before casting in the hot mold. A book mold was used to cast test plaques in the lab. The mold was preheated at 120° C. in an oven and then removed from the oven to pour the components mixture under the fume hood. Then the mold was quickly placed in the same oven to precure at 120° C. for 4 min and then move the whole mold to another oven set at 200° C. to fully cure for another 5 min. The plaques were then removed from the mold to cool down to room temperature for future testing.

The physical properties of the test plaques of Example 1 were measured in accordance with the following protocol:

| | |
|---|---|
| ASTM D790 | Flexural Modulus, psi (MPa) |
| ASTM D790 | Flexural Stress, peak, psi (MPa) |
| ASTM D790 | Flexural Strain, peak, % |
| ASTM D638 | Tensile Modulus, psi (MPa) |
| ASTM D638 | Tensile Stress, peak, psi (MPa) |
| ASTM D638 | Tensile Strain at Break, % |
| ASTM D256 | Notched Izod Impact Strength, ft-lb/in (J/m) |
| ASTM D648 | Heat Deflection Temperature @ 66 psi, ° C. |
| ASTM D2240 | Hardness Shore D |
| DIN 53240-1 | OH value |

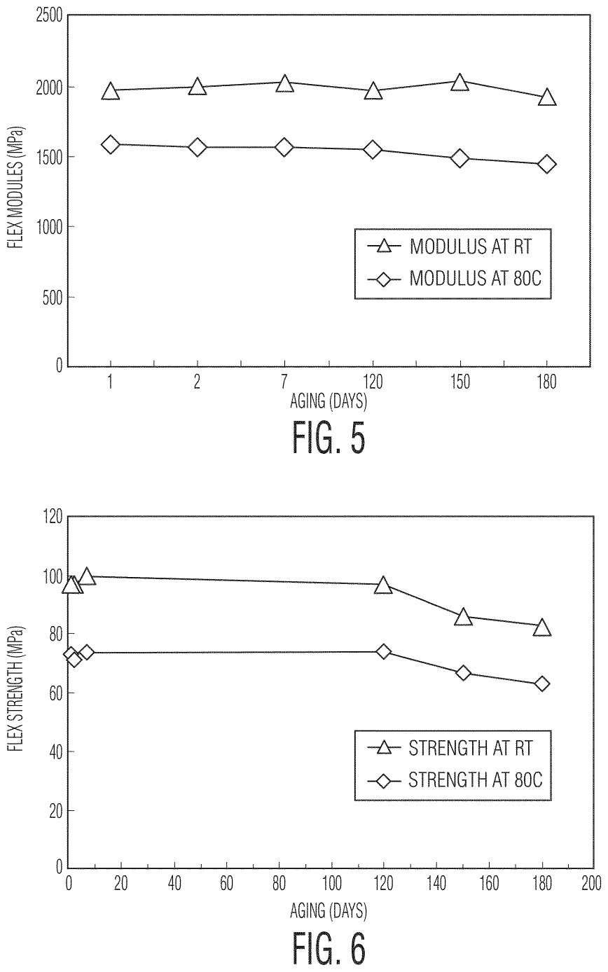

FIGS. 5 and 6 summarizes the flex properties of the test plaques made at different times within the six months of storage time. Both Flex Modulus and strength at room temperature and 80° C. are consistent and do not substantially change, suggesting a very stable chemistry.

### Example 3: Pultrusion

The system of Example 1 was separately trialed two times on two different machines. The first trial was successfully performed to find the best temperature profile. In the second trial, a longer die 48″ equipped with four heating zones were used that resulted in the best properties. The die was a flat profile with a thickness of 3 mm and width of 10 cm. 116 Roving from Owens Corning Type 300 4400 Tex were used to make pultruded profiles.

The component A (resin):B (iso) ratio was set to 100:285 by weight to produce an Index of 385. Two temperature profiles were trialed: 1) 350-400-400-350° F. and 2) 300-410-410-400° F. Also, four production speeds of 20, 30, 40, and 50 inches per minute were tested. The system showed an excellent wet out with a very smooth pultruded part surface. The pull force was about 1200-1500 lbf similar to other commercial systems.

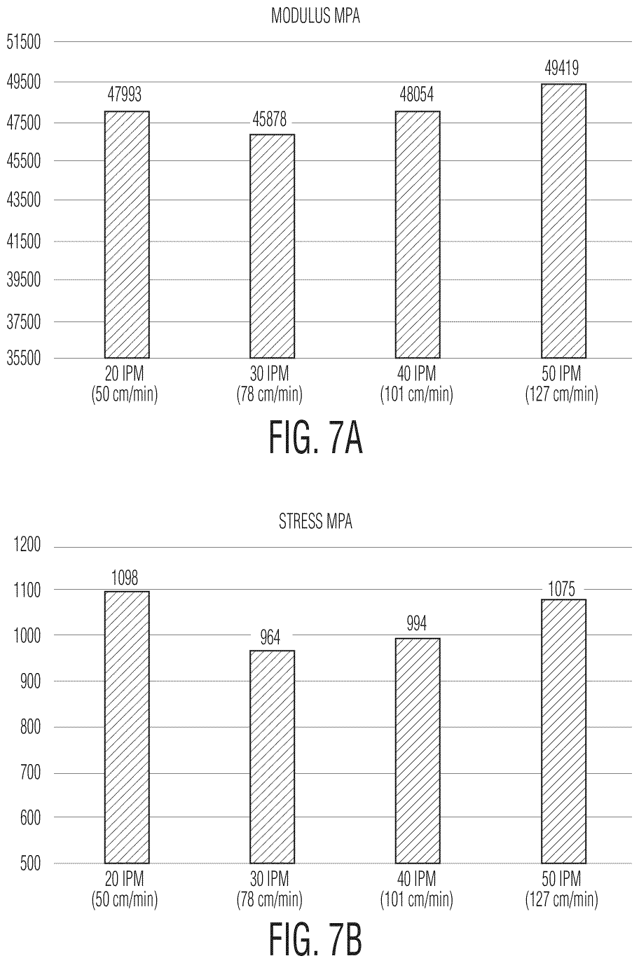

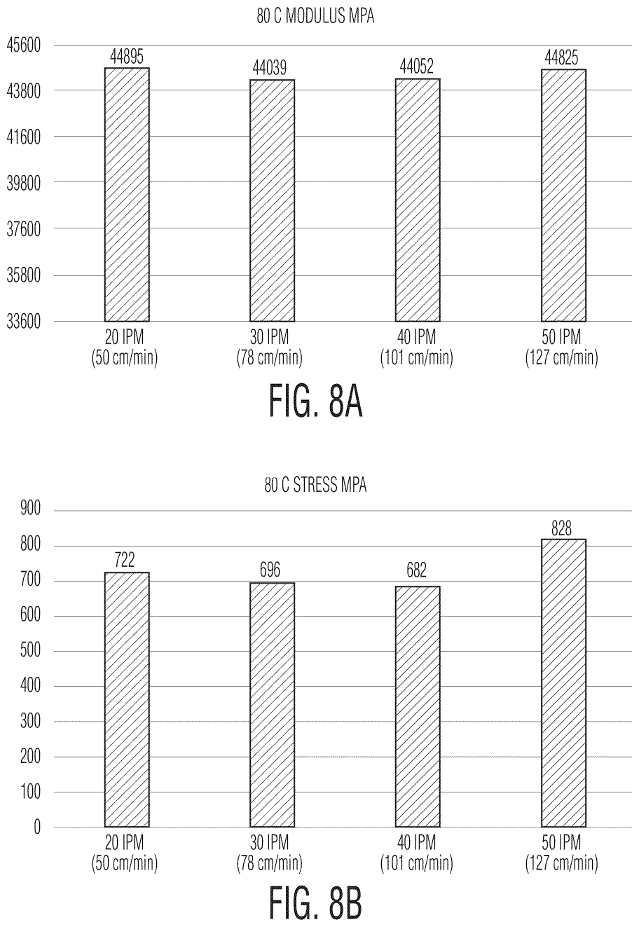

The elastic modulus and flex strength were measured at room temperature and at 80° C. FIGS. 7A and 7B show the results at room temperature and FIGS. 8A and 8B show the results at 80° C. The elastic modulus is consistent and does not substantially change with temperature up to 80° C. (compare FIG. 7A at room temp. to FIG. 8A at 80° C.). Likewise, the flex strength is consistent and does not substantially change with temperature up to 80° C. (compare FIG. 7B at room temp. to FIG. 8B at 80° C.).

It can be seen from the results that the system possesses excellent Flex modulus and strength at room temperature even exceeding 1 GPa of Flex strength. At 80° C., the pultruded parts retain more than 85% of the mechanical properties which is very good when compared to other commercial systems.

The forgoing description of particular aspect(s) is merely exemplary in nature and is in no way intended to limit the scope of the invention, its application, or uses, which can, of course, vary. The disclosure is provided with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials can be interchangeable such that the description of the invention can include multiple parts or steps arranged in many ways as is readily appreciated by one of skill in the art.

It will be understood that, although the terms “first,” “second,” “third” etc. may be used herein to describe various elements, components, regions, and/or steps, these elements, components, regions, layers, and/or steps should not be limited by these terms. These terms are only used to distinguish one element, component, region, layer, or section from another element, component, region, layer, or section. Thus, “a first element,” “component,” “region,” “layer,” or “section” discussed above could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits, and ranges appear in one or more claims below. All numerical values are “about” or “approximately” the indicated values, and take into account experimental error and variations that would be expected by a person having ordinary skill in the art.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Various modifications of the present invention, in addition to those shown and described herein, will be apparent to those skilled in the art of the above description. Such modifications are also intended to fall within the scope of the appended claims.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular aspects of the invention, but is not meant to be a limitation upon the practice thereof.

1. A process for producing a pultruded polyurethane-polyisocyanurate-fiber composite part, comprising:
obtaining a reaction mixture by mixing:
A) an isocyanate-reactive component comprising:
i. a polyol having an average functionality of 1.8 to 5.0 and a hydroxyl number of 200 to 500, and
ii. an alkali metal catalyst obtainable by introducing an alkali metal salt or alkaline earth metal salt into a compound R—NH—CO—R′ containing urethane groups, with R being not hydrogen and/or not COR″;
B) an isocyanate component comprising:
i. at least one isocyanate compound, and
ii. a compound containing one or more epoxide groups; and
impregnating at least one fibrous reinforcing agent with the reaction mixture to obtain the pultruded polyurethane-polyisocyanurate-fiber composite part.

2. The process according to claim 1, further comprising mixing a chain extender with at least one of the isocyanate-reactive component or the isocyanate component.

3. The process according to claim 1, wherein
an amount of alkali metal ions or alkaline earth metal ions per urethane group in the alkali metal catalyst is 0.0001 to 3.5, based on the number of alkali metal or alkaline earth metal ions and urethane groups,
a fraction of the compound containing one or more epoxide groups is from 0.3 to 15 wt %, based on the total weight of compound containing one or more epoxide groups and isocyanate of the isocyanate component, and
an isocyanate index is 100 to 450.

4. The process according to claim 1, wherein an isocyanate index is 100 to 450.

5. The process according to claim 1, wherein a first polyisocyanate is used as the at least one isocyanate compound, and the compound containing urethane groups in the alkali metal catalyst is a reaction product of a second polyisocyanate and a compound having an OH group.

6. The process according to claim 1, wherein the at least one isocyanate compound is a polyisocyanate prepolymer having an NCO content of 5 to 33 wt %.

7. The process according to claim 1, wherein the alkali metal catalyst is a reaction product of a second isocyanate different from the at least one isocyanate compound and a compound having at least two OH groups, the second isocyanate being used in a stoichiometric excess.

8. The process according to claim 1, wherein an amount of alkali metal ions or alkaline earth metal ions per isocyanate group in the isocyanate component and also in the alkali metal catalyst is 0.0001 to 0.3, based on a number of alkali metal or alkaline earth metal ions and isocyanate groups.

9. The process according to claim 1, wherein the compound containing epoxide groups comprises two, three or more epoxide groups per molecule.

10. The process according to claim 1, wherein the alkali metal salt or alkaline earth metal salt in the alkali metal catalyst is lithium chloride.

11. The process according to claim 1, wherein the compounds containing one or more epoxide groups in the compound containing one or more epoxide groups are used in an amount such that an equivalents ratio of epoxide group to isocyanate group in the isocyanate component is 0.1 to 2.0.

12. A polyurethane-polyisocyanurate-fiber composite part obtainable by a process according to claim 1.

13. A polyurethane-polyisocyanurate-fiber composite part obtainable by a process according to claim 1, wherein the polyurethane-polyisocyanurate-fiber composite part comprises the at least one fibrous reinforcing agent in a range of 25 wt % to 80 wt % and has a glass transition of 200° C. or more.

14. The polyurethane-polyisocyanurate-fiber composite part of claim 13, having a glass transition of 230° C. or more.

15. A system for producing a pultruded polyurethane-polyisocyanurate-fiber composite part, comprising:
A. an isocyanate-reactive component comprising
iii. a polyol having an average functionality of 1.8 to 5.0 and a hydroxyl number of 200 to 500, and
iv. an alkali metal catalyst obtainable by introducing an alkali metal salt or alkaline earth metal salt into a compound R—NH—CO—R′ containing urethane groups, with R being not hydrogen and/or not COR″;
B. an isocyanate component comprising:
iii. at least one isocyanate compound, and
iv. a compound containing one or more epoxide groups.

16. The system according to claim 15, further comprising a chain extender with at least one of the isocyanate-reactive component or the isocyanate component.

17. The system according to claim 15, wherein
an amount of alkali metal ions or alkaline earth metal ions per urethane group in the alkali metal catalyst is 0.0001 to 3.5, based on the number of alkali metal or alkaline earth metal ions and urethane groups,
a fraction of the compound containing one or more epoxide groups is from 0.3 to 15 wt %, based on the total weight of compound containing one or more epoxide groups and isocyanate of the isocyanate component, and
an isocyanate index is 200 to 850.

18. The system according to claim 15, wherein an amount of alkali metal ions or alkaline earth metal ions per isocyanate group in the isocyanate component and also in the alkali metal catalyst is 0.0001 to 0.3, based on a number of alkali metal or alkaline earth metal ions and isocyanate groups.

19. The system according to claim 15, wherein the alkali metal salt or alkaline earth metal salt in the alkali metal catalyst is lithium chloride.
